(19) United States
(12) Patent Application Publication
(10) Pub. No.: US 2026/0094188 A1
(43) Pub. Date: Apr. 2, 2026

(54) MULTI-DIMENSIONAL REVIEW SYSTEM AND METHOD

(71) Applicant: Vinay Sharma, Zirakpur (IN)

(72) Inventor: Vinay Sharma, Zirakpur (IN)

(21) Appl. No.: 19/113,937

(22) PCT Filed: Sep. 20, 2023
(86) PCT No.: PCT/IN2023/050870

§ 371 Date: Mar. 21, 2025

(30) Foreign Application Priority Data
Sep. 21, 2022 (IN) 202211054123

(51) Int. Cl. G06Q 30/0282; G06Q 30/018

(52) U.S. Cl. CPC G06Q 30/0282; G06Q 30/0185

(57) ABSTRACT

The present invention relates to a multi-dimensional review system and method. The multidimensional review system comprises an information server, a central server, and at least one user device. The central server is communicatively coupled to the information server. The user device sends an information query to the information server, the central server or both through a communication network. The information query comprises a request for data related to at least one entity, at least one review, or a combination thereof. The central server or the information server receives the information query and aggregates the data related to the at least one entity, the at least one review, or a combination thereof based on the information query. The central server provides the at least one review related to the at least one entity in the information query. As a result, enabling authentic reviews.

### TECHNICAL FIELD

The present invention relates to a system and method for providing a review to different entities in a networked environment, and more particularly to a multi-dimensional review system and method.

### BACKGROUND

### Interpretation Considerations

This section describes the technical field in detail and discusses problems encountered in the technical field. Therefore, statements in the section are not to be construed as prior art.

### Discussion

Technology significantly influences human lifestyle and decision-making. An end-user or consumer searches online for goods, services, businesses, organisations, websites, particular information on a page, or any entity being traded. Earlier, the decisions were less influenced due to the limited information access to the end-user or consumer (used interchangeably throughout the patent application), but technology-enabled access to the information in large quantity led to a change in consumer behavior. This profusion of information enables the end-user to select among available choices, considering various circumstances and scenarios. However, the majority of the information available regarding goods or services in the networked environment can be controlled or influenced. Information can be verified using a variety of methods. However, there are numerous ways to bypass or misuse these. Hence, misleading information influences the end-user to make a wrong decision or selection.

In one example, most sellers or merchants are available online, offering the same or different goods or services to the end-user over their portals, intermediate portals (such as Google, Amazon, Snapdeal, etc.), online listing portals, or any other networked environment. The end-user verifies multiple aspects of the goods or services, such as quality, material, value, or after-purchase services, before considering the offered goods or services. The end-user verifies the aspects in two ways, one is the goods or services information or description provided by the merchant or seller through the networked environment, and the other is the reviews provided by the existing end-users or experts. The information provided by the merchant is always beneficial but could be deceptive as well. The reviews provided by the existing end-users on the goods or services directly influence the decision of the current end-user. However, the reviews could be falsified depending on various circumstances, which are discussed further.

In the first scenario, a merchant or seller is selling goods or services on their website. This provides the merchant or seller complete control over the content, and hence, reviews can be easily falsified. The key intention of the merchant or seller is generally high margins over the goods or services, his preferences, and/or available inventory, among others. Similarly, many institutes, companies, universities, and other non-traditional businesses claim themselves to be the best in business. Therefore, it is always difficult to trust such ratings or market standing before making any decision.

In the second scenario, several marketplaces allow merchants to sell the goods or services through their platforms to gain new customers and increase their profits. A relatively new merchant is not able to establish goodwill due to the presence of old merchants and is given an initial zero rating. To sustain this, merchants or any reputed branding agency post fake ratings and reviews over the portals, misleading the end-user due to the lack of verified information.

In the third scenario, various search engines also maintain reviews and ratings. Anyone with a login account, usually email-based, can post reviews. There is no consideration of the fact that the reviewer has any vested interest or not in that rating. The posted reviews or ratings are not verified and do not constitute the basis of accurate information.

In another example, the listing portals allow merchants to share their goods or services descriptions, merchant information, and merchant contact details. The information is shown to the end user, and upon consideration by the end user, the contact information is provided in exchange for a small fee. The review and rating are generated based on how frequently the contact information of a particular seller is requested. There is no validated method or system to overcome such situations. Furthermore, in some scenarios, the listing portals run paid models to provide top-ranking upon search and specific tag ratings like a most trusted, portal choice of the month, etc.

### PRIOR ART

One such system and method, disclosed in the US publication 20090210444A1relates to a system and method for collecting bonafide reviews of ratable objects. The system and method automatically determine the authenticity of a rating of a particular object based upon an evaluated risk level associated with rating information, rater profile information, and time frame of received rating information such as rater personal information, VPN, internet protocol (IP), and other electronic evidence. However, the system only verifies the rater profile using some well-known methods such as tracking of the internet protocol (IP), cookies, etc. The system fails when the rater information is maintained securely per the privacy regulation and compliance.

Another US publication, 20160314476A1, discloses a review validation system and method for business service providers using a unique identifier. A merchant generates the unique identifier and transmits it to an end user. Reviews are associated with the identifier and can be used for particular service(s) or product(s). The reviews are easily altered because the identifier is provided by the merchant. Therefore, fake identifiers can be generated and used deliberately.

Other available systems validate the reviews based on location-based tracking of a person reviewing the goods and services of the provider. The system enables the person to trace unverified reviews, such as reviews from the geological locations where the merchant or provider does not have any area of business or is not providing its services or repeatedly reviews from a particular geo-location. The system aids in location-based review verification. However, the information provided is still unauthentic. Further, accessing the geo-location of the user can raise a privacy threat to the user. The geolocation of the user could be used and sold to advertising companies. The available system fails to consider privacy policies and violates the policy guidelines. Further, a proxy network can be used to bypass location.

While the above-mentioned prior art attempted to solve the problems, there are limitations in the context of verifying the authenticity of the information provided in the review. The majority of reviews are found to be overly positive. The merchants or providers seek the help of their friends, colleagues or other known people to post unauthentic and fake reviews to increase the rating to promote their sales and profit.

Therefore, there is a need for a review system and method to enable authentic reviews.

### SUMMARY

The object is solved by independent claims, and embodiments and improvements are listed in the dependent claims. Hereinafter, what is referred to as “aspect”, “design”, or “used implementation” relates to an “embodiment” of the invention and when in connection with the expression “according to the invention”, which designates steps/features of the independent claims as claimed, designates the broadest embodiment claimed with the independent claims.

An object of the present invention is to provide a multi-dimensional review system and method for reducing the count of fraudulent reviews.

Another object of the present invention is to provide a multi-dimensional review system and method for validating the authenticity of a user and the review provided by the user.

Another object of the invention is to provide a global rating corresponding to at least one entity across the different platforms for addressing the issue of fake reviews. Therefore, the system provides a robust environment by presenting correct reviews and information.

According to the first aspect, the present invention provides a multi-dimensional review system that comprises an information server, a central server, and at least one user device. The central server is communicatively coupled to the information server. The at least one user device sends an information query to the information server, the central server, or both through a communication network. The information query comprises a request for data related to at least one entity, at least one review, or a combination thereof. The central server or the information server receives the information query and aggregates the data related to the at least one entity, the at least one review, or a combination thereof based on the information query. The central server provides the at least one review related to the at least one entity in the information query.

In an embodiment, according to the present invention, the central server communicates with the information server, at least one user device, or a third-party server to compute the review.

In an embodiment, according to the present invention, the information query contains a unique identifier.

In another embodiment, according to the present invention, the at least one review comprises a star rating, a score, a comment, a badge, a comparative metric, or a combination thereof.

According to another aspect, the present invention provides a method for computing multi-dimensional review. The method comprises the steps of receiving a request for a review process initiation for at least one user interaction, presuming a review for at least one entity for the at least one user interaction based on historical data, sending a confirmation request with the review to the at least one user, initiating a counter against the confirmation request, wherein the counter is based on time, attempts, or a combination thereof, and updating the review based on a response of the user to the confirmation request or counter expiration.

In an embodiment, according to the present invention, the review process initiation comprises determining a unique identifier related to the at least user interaction and corresponding entity.

In another embodiment, according to the present invention, presuming a review includes predicting a review based on the historical data using artificial intelligence or preset rules.

In an embodiment, according to the present invention, predicting the review includes determining a rating and a confidence level based on the user interaction and the historical data.

In an embodiment, according to the present invention, updating the review based on a response of the user to the confirmation request or counter expiration. The response includes a) acceptance of the review; b) rejection with an updated review; c) rejection; or d) no response.

According to another aspect, the present invention provides a system for computing a multi-dimensional review that comprises at least one user device and a server. The server is communicatively coupled to the at least one user device. The server is configured to perform the steps of receiving a request for a review process initiation for at least one user interaction, presuming a review for at least one entity for the at least one user interaction based on historical data, sending a confirmation request with the review to the at least one user; initiating a counter against the confirmation request, wherein the counter is based on time, attempts, or a combination thereof, and updating the review based on a response of the user to the confirmation request or counter expiration.

In an embodiment, according to the present invention, the server is a central server, an information server, a third-party server, or a combination thereof.

Further objectives, features, and advantages of the present invention will become apparent when studying the following detailed disclosure, the drawings, and the appended claims. Those skilled in the art will realise that different features of the present invention can be combined to create embodiments other than those described in the following.

### BRIEF DESCRIPTION OF THE DRAWINGS

Various aspects, as well as embodiments of the present invention, are better understood by referring to the following detailed description. To better understand the invention, the detailed description should be read in conjunction with the drawings.

FIG. 1 is a schematic illustration of a multi-dimensional review system in accordance with an exemplary embodiment of the present invention;

FIG. 1(A) is a schematic illustration of a multi-dimensional review system in accordance with another exemplary embodiment of the present invention;

FIG. 2 is a method for computing a multi-dimensional review in accordance with an exemplary embodiment of the present invention;

FIG. 3 is a method for classifying at least one user in accordance with an exemplary embodiment of the present invention;

FIG. 4A is a method for computing a multi-dimensional review of a first-time user in accordance with an exemplary embodiment of the present invention; and

FIG. 4B is a method for computing a multi-dimensional review of a repeated user in accordance with an exemplary embodiment of the present invention.

### DETAILED DESCRIPTION

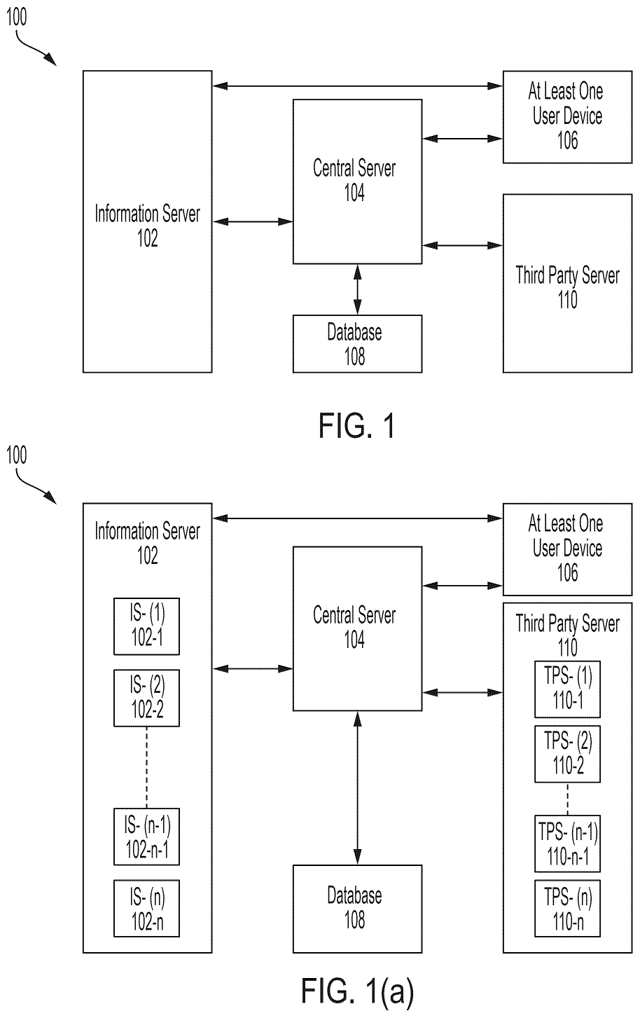

FIG. 1 is a schematic illustration of a multi-dimensional review system 100 in accordance with an exemplary embodiment of the present invention. The multi-dimensional review system 100 comprises an information server 102, a central server 104, at least one user device 106, a database 108, and a third-party server 110.

The information server 102 acts as a source of any information requested by the at least one user device 106. The information server 102 communicates to receive and update the data from different sources including but not limited to individual merchant portals, third-party portals such as Google, Amazon, Snapdeal, listing portals, job portals, educational institutions, offline stores with an online presence, or any other entity in a networked environment. The information server 102 may include one or more information servers (IS) 102-1, 102-2, . . . , 102-n-1, and 102-n, as shown in FIG. 1(A).

The central server 104 is communicatively coupled to the information server 102. The central server 104 is located remotely from the information server 102. The central server 104 may include one or more sub-modules. The one or more sub-modules may include one or more information servers (102-1, 102-2, . . . , 102-n), one or more computational servers (not shown here), or a combination thereof, as shown in FIG. 1(A). Further, the central server 104 and the information server 102 are distributed in the cloud infrastructure and maintained at multiple locations with a connected network. Alternatively, the central server 104 and the information server 102 are integrated as a single module to form the multi-dimensional review system 100.

The at least one user device 106 includes but is not limited to a mobile phone, tablet, computer, spatial computing device and any other interactive device connected to the internet. The at least one user device 106 sends an information query to the information server 102, the central server 104 or both through a communication network. The communication network may support any number of suitable data communication protocols, techniques, or methodologies, including radio frequency (RF), infrared (IrDA), Bluetooth, ZigBee (and other variants of the IEEE 802.15 protocol), a wireless fidelity Wi-Fi or IEEE 802.11 (any variation), IEEE 802.16 (WiMAX or any other variation), global system for mobile communication (GSM), general packet radio service (GPRS), enhanced data rates for GSM evolution (EDGE), long term evolution (LTE), cellular protocols (2G, 2.5G, 2.75G, 3G, 4G or 5G), near field communication (NFC), satellite data communication protocols, or any other protocols for wireless communication.

The information query comprises a request for data related to at least one entity, at least one review, or a combination thereof. The at least one entity includes but is not limited to goods, services, providers, end-users, and any attribute that has online visibility. The at least one review comprises a star rating, a score, a comment, a badge, a comparative metric, or a combination thereof.

The central server 104 or the information server 102 handles the data requests from all the servers of the multi-dimensional review system 100. The central server 104 comprises at least one processing module, and a memory module (not shown) to carry out the overall operation of the multi-dimensional review system 100. The processing module is capable of executing software instructions or algorithms to implement functional aspects of the present invention. The processing module can be any commercially available processor or a cloud system. The processing module can also be implemented as a digital signal processor (DSP), a controller, a microcontroller, a designated system on chip (SoC), an integrated circuit implemented with a field programmable gate array (FPGA), an application-specific integrated circuit (ASIC), or a combination thereof. The processing module can be implemented using a co-processor for complex computational tasks.

The memory module may include any of the volatile memory elements (for example, random access memory, such as DRAM, SRAM, SDRAM, etc.), non-volatile memory elements (for example, ROM, hard drive, etc.), other storage media or combinations thereof. The memory module may have a distributed architecture, where various components are situated remotely from one another but can be accessed using the processing module. The software in the memory module can include one or more software programs, and machine learning algorithms, each of which includes an ordered listing of executable instructions for implementing logical functions. Further, the processing module can be implemented using a cloud architecture.

The central server 104 or the information server 102 receives the information query. The central server 104 or the information server 102 aggregates the data related to the at least one entity, the at least one review, or a combination thereof based on the information query. The information query contains a unique identifier. The unique identifier includes an entity identifier, a transaction identifier, or a combination thereof.

The central server 104 is connected to a database 108 using the communication network. Alternatively, the database 108 may be an integral part of the central server 104. The database 108 stores the previous rating related to entities, including but not limited to, merchants, or any other entity. The database 108 provides authentic historical data to the central server 104. Alternatively, distributed databases, cloud infrastructure, blockchain, or any AI-based technology can also be implemented to fetch, store, and analyze historical data and details.

The central server 104 maintains universal review information for each entity in the multi-dimensional review system 100. The central server 104 communicates with the at least one information server 102, the database 108 and the third-party server 110 to compute the universal review information. The central server 104 provides the at least one review related to the at least one entity in the information query.

The third-party server 110 is located remotely from the information server 102 and the central server 104. Alternatively, the third-party server 110 may be an integral part of the information server 102 or the central server 104. The third-party server 110 provides additional information to establish the authenticity and trust of the rating. The third-party server 110 provides transaction identifiers and information related to the merchant or provider and at least one user device 106. The information can be used separately or in combination. The third-party server 110 includes payment servers (unified payments interface (UPI) servers), invoicing servers, know-your-customer (KYC) servers, or any other data server required depending upon the functionality, nature, and multi-dimensional review system 100 requirement. The third-party server 110 may include one or more third-party servers (TPS) 110-1, 110-2, 110-3, . . . , 110-n-1, and 110-n, as shown in FIG. 1(a).

The multi-dimensional review system 100 is a networked architecture of the information server 102, the central server 104, at least one user device 106, the database 108, and a third-party server 110. The multi-dimensional system 100 computes the rating by collecting real-time data from the central server 104 based on the transaction initiated by the at least one user device 106. The key components could be arranged separately or grouped in multiple ways based on functionality, nature, user requirements, and advancement in the technology domain.

The central server 104 acts as the brain of the multi-dimensional review system 100. The central server 104 computes presumed review by performing a set of instructions on the received information from the at least one information server 102, and the third-party server 110 along with the historical data from the database 108. The central server 104 may communicate the presumed review to the information server 102 upon computation. The central server 104 may display the presumed review of the at least one entity on the connected networked environment.

During operation, at least one user operating the at least one user device 106 sends an information query to the information server 102, the central server 104 or both through the communication network. The information query comprises the request for data related to at least one entity, at least one review, or a combination thereof. The central server 104 or the information server 102 receives the information query. The central server 104 or the information server 102 aggregates the data related to the at least one entity, the at least one review, or a combination thereof based on the information query. The central server 104 provides the at least one review related to the at least one entity in the information query. The at least one user of the at least one user device 106 selects a desired entity from multiple entities based on the at least one review. The at least one user of the at least one user device 106 purchases or buys the desired entity.

The review process is initiated as soon as at least one user of at least one user device 106 buys or purchases the at least one entity. The at least one user of the at least one user device 106 conducts transactions online or offline. The information server 102, the third-party server 110 or both send the transaction details and other information such as entity details, user details, and merchant details to the central server 104. The central server 104 classifies the at least one user as a first-time user or a repeated user based on the unique identifier and the historical data. The central server 104 verifies authentication on the classified user. The authentication is verified using at least one of the methods but is not limited to one-time passwords over emails or texts, automated calls, social media profiles, email authentications, or any other methods known in the art at the time of implementation. The data associated with the authenticity of the at least one user operating is collected to establish trust and confidence level. If the at least one user fails to submit the data requested during the authentication process, then the central server 104 identifies the at least one user as a fake user. The central server 104 allocates a grace period for the merchant or provider to remove or delete the review. The central server 104 marks the merchant or provider as a fake merchant or provider after the grace period expiration. The grace period includes but is not limited to three days, a week, or a month.

After successful authentication, the central server 104 identifies the at least one user of the at least one user device 106 as a genuine user. After verifying the authenticity of at least one user operating the at least one user device 106, the central server 104 raises a request for a review process initiation for at least one user interaction. The central server 104 determines a unique identifier related to the at least user interaction and the corresponding entity. The at least one user interaction indicates the buying or purchasing of the at least one entity by the at least one user. The central server 104 analyzes the historical data related to the merchant or provider, the at least one user, the transaction and the at least one entity. The central server 104 presumes a review of the at least one entity for the at least one user interaction based on historical data.

The presuming of a review includes predicting a review based on the historical data using artificial intelligence or preset rules. The artificial intelligence or preset rules include priorly defined software algorithms stored in the memory module. The prediction of the review includes determining a rating and a confidence level based on the at least one user interaction and the historical data. For the genuine user, the central server 104 automatically computes the highest possible rating and lowest confidence level corresponding to at least one entity.

The central server 104 sends a confirmation request with the review to the at least one user of the at least one user device 106. The central server 104 initiates a counter against the confirmation request. The counter is based on time, attempts, or a combination thereof. The at least one user device 106 transmits a response to the central server 104. The central server 104 updates the review based on the response of the at least one user to the confirmation request or counter expiration. The response includes acceptance of the review, rejection with an updated review, rejection, or no response. The central server 104 transmits the updated review to the at least one information server 102 for display. The updated review is also stored in the database 108 to build a global rating of the at least one entity for future consideration and computation.

An initial presumed review is preferably set high with a low confidence level. The central server 104 updates the confidence level and rating based on the response from the at least one user of the at least one user device 106.

If a response is not submitted after the central server 104 sends a confirmation request from at least one user of the at least one user device 106, the central server 104 sends a reminder request for the submission of the response to the confirmation request. The central server 104 may send multiple reminder requests to the at least one user to submit the review. In another case, if the at least one user does not submit the response in a definite time, the presumed review is modified based on the historical data using the artificial intelligence or the preset rules.

In one embodiment of the present invention, for a first-time user, the central server 104 presumes the review including a five-star rating and zero confidence level based on historical data using artificial intelligence or preset rules. The central server 104 sends a confirmation request with a review to the first-time user.

In one embodiment of the present invention, for a repeated user, the central server 104 presumes the review including a five-star rating or adding one to a last rating and 50% confidence level based on historical data using artificial intelligence or preset rules. The central server 104 sends a confirmation request with a review to the repeated user.

In one example, if the at least one user of the at least one user device 106 accepts the confirmation request with the review, then the central server 104 updates the presumed review. The central server 104 boosts the confidence level based on the response of the at least one user. For a first-time user, the central server 104 updates the presumed review including the five-star rating and a 50% confidence level. For a repeated user, the central server 104 updates the presumed review including the five-star rating and a 75% confidence level. If the at least one user of the at least one user device 106 accepts the confirmation request with the review and provides a positive comment. The central server 104 analyzes the positive comment using natural language processing (NLP). For a first-time user and a repeated user, the central server 104 updates a presumed review including the five-star rating and a 100% confidence level.

In a second example, if the at least one user of the at least one user device 106 rejects the confirmation request with the review and provides a new rating and a negative comment to the central server 104. The central server 104 updates the review based on the new rating and the negative comment. The central server 104 analyzes the negative comment using natural language processing (NLP). The new rating includes a rating less than the five-star rating. The new rating includes but is not limited to a four-star rating, a three-star rating, a two-star rating, or a one-star rating. In one example, the new rating is a four-star rating. The central server 104 boosts the confidence level based on the response of the at least one user. For a first-time user and a repeated user, the central server 104 considers an updated rating (four-star rating) as the final rating with a 100% confidence level. If the at least one user of the at least one user device 106 rejects the presumed review and provides a new rating to the central server 104. Then the central server 104 updates the presumed review based on the new rating. For a first-time user, the central server 104 considers the updated rating (four-star rating) as the final rating with a 50% confidence level. For a repeated user, the central server 104 considers the updated rating (four-star rating) as the final rating with a 75% confidence level. If the at least one user of the at least one user device 106 rejects the presumed review and provides no new rating to the central server 104. For a first-time user, the central server 104 updates the new rating (four-star rating) by subtracting one from the five-star rating with a 25% confidence level. The central server 104 decreases the confidence level to the half of the initial presumed confidence level based on the response of the at least one user. For a repeated user, the central server 104 updates the new rating (four-star rating) by subtracting one from the five-star rating with a 25% confidence level.

In a third example, if the at least one user of the at least one user device 106 does not respond to the confirmation request with a review. Then the central server 104 sends a reminder request to the at least one user to submit the review. The central server 104 may send multiple reminder requests to the at least one user to submit the review. For a first-time user, if no response is received within a definite period of time (for example three days, seven days, or a month), then the central server 104 updates the presumed review including the five-star rating with a 50% confidence level as a final review. For a repeated user, the central server 104 updates the presumed review including the five-star rating with a 75% confidence level as a final review. In both cases, the central server 104 boosts the confidence level based on the response of the first-time user and the repeated user.

The central server 104 may transmit the updated the presumed review to the at least one information server 102, the at least one user device 106, the database 108, the third-party server 110 or both for display and storage.

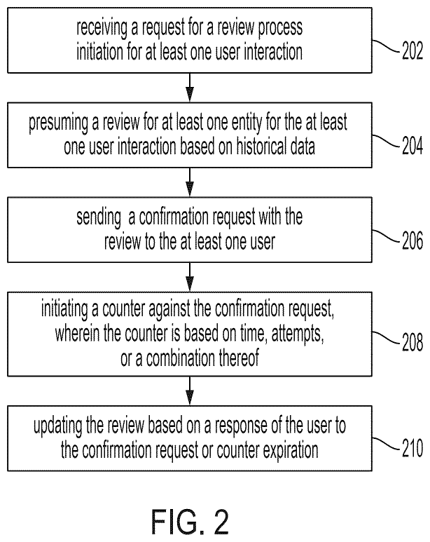

FIG. 2 is a method 200 for computing a multi-dimensional review in accordance with an exemplary embodiment of the present invention comprising the steps of receiving (202) a request for a review process initiation for at least one user interaction, presuming (204) a review for at least one entity for the at least one user interaction based on historical data, sending (206) a confirmation request with the review to the at least one user, initiating (208) a counter against the confirmation request, wherein the counter is based on time, attempts, or a combination thereof and updating (210) the review based on a response of the user to the confirmation request or counter expiration.

The review process initiation (202) comprises determining a unique identifier related to the at least user interaction and corresponding entity. The unique identifier includes an entity identifier, a transaction identifier, or a combination thereof.

The presuming a review (204) includes predicting a review based on the historical data using artificial intelligence or preset rules. The prediction of the review includes determining a rating and a confidence level based on the at least one user interaction and the historical data.

The updating (210) of the review is based on a response of the user to the confirmation request or counter expiration. The response includes acceptance of the review, rejection with an updated review, rejection, or no response. The updating (210) of the review further includes the step of communicating the review to a server involved in the user interaction. The server is a central server, an information server, a third-party server, or a combination thereof.

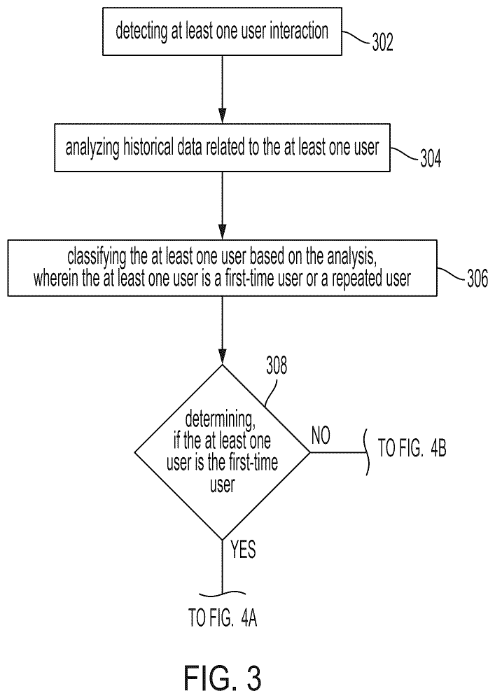

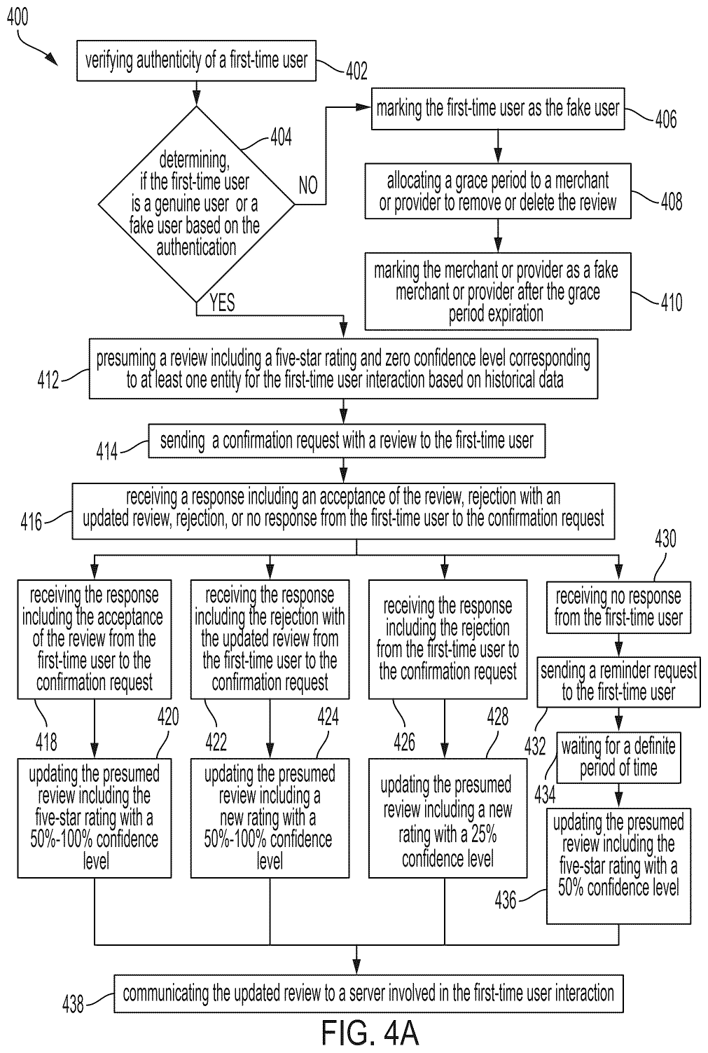

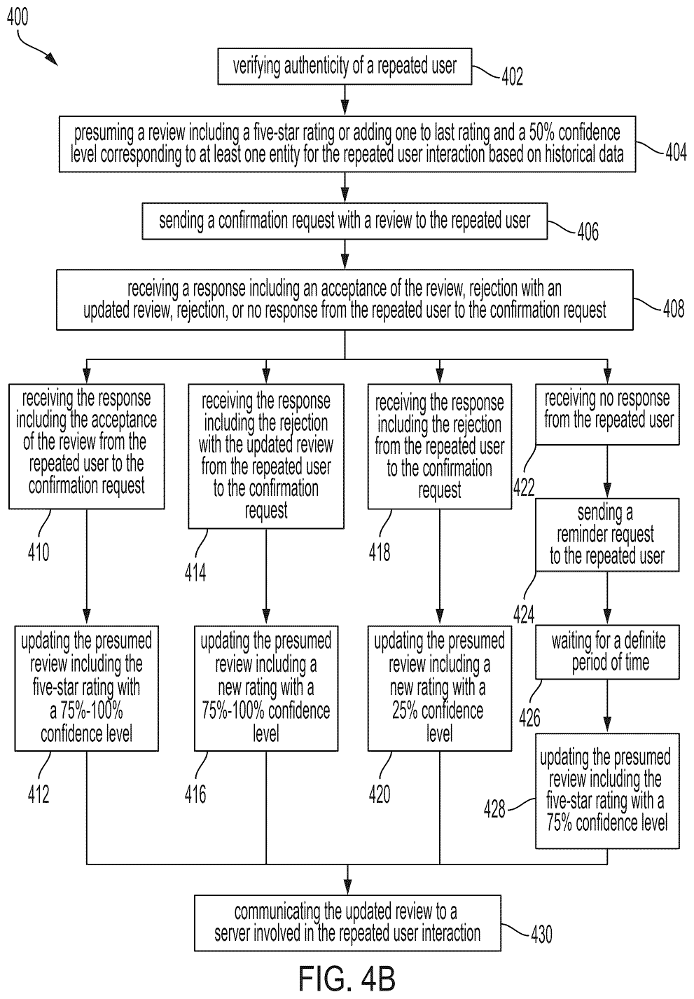

FIG. 3 is a method 300 for classifying at least one user in accordance with an exemplary embodiment of the present invention comprising the steps of detecting (302) at least one user interaction, analyzing (304) historical data related to the at least one user, classifying (306) the at least one user based on the analysis, wherein the at least one user is a first-time user or a repeated user, and determining (308), if the at least one user is the first-time user. If yes, then go to FIG. 4A or if no, then go to FIG. 4B.

The classification of (306) the at least one user includes determining a unique identifier related to the at least user interaction and corresponding entity. The unique identifier includes an entity identifier and a transaction identifier.

FIG. 4A is a method 400 for computing a multi-dimensional review of a first-time user in accordance with an exemplary embodiment of the present invention comprising the steps of verifying (402) authenticity of a first-time user, determining (404), if the first-time user is a genuine user or a fake user based on the authentication, if no, go to step 406 or if yes, go to step 412, marking (406) the first-time user as the fake user, allocating (408) a grace period to a merchant or a provider for removing or deleting the review, marking (410) the merchant or provider as a fake merchant or provider after the grace period expiration, presuming (412) a review including a five-star rating and zero confidence level corresponding to at least one entity for the first-time user interaction based on historical data, sending (414) a confirmation request with a review to the first-time user, receiving (416) a response including an acceptance of the review, rejection with an updated review, rejection, or no response from the first-time user to the confirmation request, receiving (418) the response including the acceptance of the review from the first-time user to the confirmation request, updating (420) the presumed review including the five star rating with a 50%-100% confidence level, receiving (422) the response including the rejection with the updated review from the first-time user to the confirmation request, updating (424) the presumed review including a new rating with a 50%-100% confidence level, receiving (426) the response including the rejection from the first-time user to the confirmation request, updating (428) the presumed review including a new rating with a 25% confidence level or receiving (430) no response from the first-time user, sending (432) a reminder request to the first-time user, waiting (434) for a definite period of time, updating (436) the presumed review including the five-star rating with a 50% confidence level and communicating (438) the updated review to a server involved in the first-time user interaction.

The authenticity of the first-time user is verified (402) using at least one of the methods but is not limited to one-time passwords over emails or texts, automated calls, social media profiles, email authentications, or any other methods known in the art at the time of implementation.

The grace period includes but is not limited to three days, a week, or a month.

The acceptance of the review includes the acceptance of the review, a positive comment, or a combination thereof. If the first-time user accepts the five-star rating and provides a positive comment, update (420) the presumed review including the five-star rating with a 100% confidence level. If the first-time user accepts the five-star rating, update (420) the presumed review including the five-star rating with a 50% confidence level. In both cases, the central server boosts the confidence level based on the response of the first-time user.

The receiving (422) of the rejection with the updated review includes receiving a new rating from the first-time user. The new rating includes a rating less than the five-star rating. The new rating includes but is not limited to a four-star rating, a three-star rating, a two-star rating, or a one-star rating. In one example, the new rating is a four-star rating. The rejection with the updated review includes the rejection with the updated review, a negative comment, or a combination thereof.

If the first-time user responds with a four-star rating and a negative comment, update (424) the presumed review including the four-star rating with a 100% confidence level. If the first-time user responds with a four-star rating, update (424) the presumed review including the four-star rating with a 50% confidence level. In both cases, the central server boosts the confidence level based on the response of the first-time user.

If the first-time user responds with the rejection, update (428) the presumed review including a new rating with a 25% confidence level. The new rating includes but is not limited to a four-star rating, a three-star rating, a two-star rating, or a one-star rating. The new rating is updated by subtracting one from the presumed rating. In one example, the new rating is a four-star rating. The central server boosts the confidence level based on the response of the first-time user. A server update (428) the presumed review including the four-star rating with a 25% confidence level.

A server may send multiple reminder requests to the first-time user. The definite period of time includes but is not limited to three days, seven days, or a month.

The server is a central server, an information server, a third-party server, or a combination thereof.

FIG. 4B is a method 400 for computing a multi-dimensional review of a repeated user in accordance with an exemplary embodiment of the present invention comprising the steps of verifying (402) authenticity of a repeated user, presuming (404) a review including a five-star rating or adding one to last rating and a 50% confidence level corresponding to at least one entity for the repeated user interaction based on historical data, sending (406) a confirmation request with a review to the repeated user, receiving (408) a response including an acceptance of the review, rejection with an updated review, rejection, or no response from the repeated user to the confirmation request, receiving (410) the response including the acceptance of the review from the repeated user to the confirmation request, updating (412) the presumed review including the five star rating with a 75%-100% confidence level, receiving (414) the response including the rejection with the updated review from the repeated user to the confirmation request, updating (416) the presumed review including a new rating with a 75%-100% confidence level, receiving (418) the response including the rejection from the repeated user to the confirmation request, updating (420) the presumed review including a new rating with a 25% confidence level or receiving (422) no response from the repeated user, sending (424) a reminder request to the repeated user, waiting (426) for a definite period of time, updating (428) the presumed review including the five-star rating with a 75% confidence level, and communicating (430) the updated review to a server involved in the repeated user interaction.

The authenticity of the repeated user is verified (402) using at least one of the methods but is not limited to one-time passwords over emails or texts, automated calls, social media profiles, email authentications, or any other methods known in the art at the time of implementation.

The grace period includes but is not limited to three days, a week, or a month.

The acceptance of the review includes the acceptance of the review, a positive comment, or a combination thereof. If the repeated user accepts the five-star rating and provides a positive comment, update (412) the presumed review including the five-star rating with a 100% confidence level. If the repeated user accepts the five-star rating, update (412) the presumed review including the five-star rating with a 75% confidence level. In both cases, the central server boosts the confidence level based on the response of the repeated user.

The receiving (414) of the rejection with the updated review includes receiving a new rating from the repeated user. The new rating includes a rating less than the five-star rating. The new rating includes but is not limited to a four-star rating, a three-star rating, a two-star rating, or a one-star rating. In one example, the new rating is a four-star rating. The rejection with the updated review includes the rejection with the updated review, a negative comment, or a combination thereof. The central server boosts the confidence level based on the response of the repeated user.

If the repeated user responds with a four-star rating and a negative comment, updating (416) the presumed review including the four-star rating with a 100% confidence level. If the repeated user responds with a four-star rating, updating (416) the presumed review including the four-star rating with a 75% confidence level.

If the repeated user responds with the rejection, the central server decreases the confidence level to the half of the initial presumed confidence level based on the response of the at least one user. The central server update (420) the presumed review including a new rating with a 25% confidence level. The new rating includes but is not limited to a four-star rating, a three-star rating, a two-star rating, or a one-star rating. The new rating is updated by subtracting one from the presumed rating. In one example, the new rating is a four-star rating. A server updates (428) the presumed review including the four-star rating with a 25% confidence level.

A server may send multiple reminder requests to the repeated user. The definite period of time includes but is not limited to three days, seven days, or a month.

The server is a central server, an information server, a third-party server, or a combination thereof.

The descriptions are merely example implementations of this application but are not intended to limit the protection scope of this application. A person with ordinary skills in the art may recognize substantially equivalent structures or substantially equivalent acts to achieve the same results in the same manner or a dissimilar manner; the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described. A function or an act should be interpreted as incorporating all modes of performing the function or act unless otherwise explicitly stated.

The description is provided for clarification purposes and is not limiting. Words and phrases are to be accorded their ordinary, plain meaning unless indicated otherwise.

We claim

1. A multi-dimensional review system comprises:
an information server;
a central server communicatively coupled to the information server; and
at least one user device sends an information query to the information server, the central server, or both through a communication network; wherein the information query comprises a request for data related to at least one entity, at least one review, or a combination thereof;
wherein the central server or the information server receives the information query and aggregates the data related to the at least one entity, the at least one review, or a combination thereof based on the information query; wherein the central server provides the at least one review related to the at least one entity in the information query.

2. The system according to claim 1, wherein the central server communicates with the information server, at least one user device, or a third-party server to compute the review.

3. The system according to claim 1, wherein the information query contains a unique identifier.

4. The system according to claim 1, wherein the at least one review comprises a star rating, a score, a comment, a badge, a comparative metric, or a combination thereof.

5. A method for computing multi-dimensional review comprising:
receiving a request for a review process initiation for at least one user interaction;
presuming a review for at least one entity for the at least one user interaction based on historical data;
sending a confirmation request with the review to the at least one user;
initiating a counter against the confirmation request; wherein the counter is based on time, attempts, or a combination thereof; and
updating the review based on a response of the user to the confirmation request or counter expiration.

6. The method according to claim 5, wherein the review process initiation comprises determining a unique identifier related to the at least user interaction and corresponding entity.

7. The method according to claim 5, wherein presuming a review includes predicting a review based on the historical data using artificial intelligence or preset rules.

8. The method according to claim 7, wherein predicting the review includes determining a rating and a confidence level based on the at least one user interaction and the historical data.

9. The method according to claim 5, wherein updating the review based on a response of the user to the confirmation request or counter expiration; wherein the response includes:
a. Acceptance of the review;
b. Rejection with an updated review;
c. Rejection; or
d. No response.

10. A multi-dimensional review system comprising:
at least one user device;
a server communicatively coupled to the at least one user device and configured to:
receiving a request for a review process initiation for at least one user interaction;
presuming a review for at least one entity for the at least one user interaction based on historical data;
sending a confirmation request with the review to the at least one user;
initiating a counter against the confirmation request; wherein the counter is based on time, attempts, or a combination thereof; and
updating the review based on a response of the user to the confirmation request or counter expiration.
